(19) United States
(12) Patent Application Publication
(10) Pub. No.: US 2008/0199573 A1
(43) Pub. Date: Aug. 21, 2008

(54) Stable Hemicellulose Paste, Method for Production thereof and Use Thereof

(75) Inventors: Ulrich Drechsler, Berlin (DE); Fritz Loth, Teltow (DE); Kay Hettrich, Potsdam (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignees: Fraunhofer-Gesellschaft zur Forderung der angewandten Forschung e.V., Munchen (DE); Dow Wolff Cellulosics GmbH, Bomlitz (DE)

(21) Appl. No.: 11/916,478

(22) PCT Filed: Jun. 7, 2006
(86) PCT No.: PCT/EP06/05424

§ 371 Date: Apr. 2, 2008

(30) Foreign Application Priority Data
Jun. 7, 2005 (DE) 10 2005 026 223.6

(51) Int. Cl. A23L 1/00

(52) U.S. Cl. 426/271; 426/661

(57) ABSTRACT

The invention relates to a stable uncrosslinked hemicellulose paste and also to a method for production thereof. The hemicellulose obtained by alkaline extraction from a hemicellulose-containing material is thereby treated in the alkaline medium with an oxidant, subsequently the pH value is reduced. Subsequent thereto, precipitation and separation of excess liquid is effected with formation of a homogeneous and stable paste. The pastes according to the invention are used in the field of foodstuffs and food additives.

The invention relates to a stable uncrosslinked hemicellulose paste. This paste according to the invention is produced by treating hemicellulose in an alkaline medium with the addition of an oxidant with subsequent precipitation and separation of excess liquid. The pastes according to the invention are used in the field of foodstuffs and food additives.

In addition to cellulose and lignin, hemicelluloses are one of the three structural components of the woody cell wall. There is termed as hemicellulose in general a group of polysaccharides of different compositions which occur in plant fibres and cell walls of grasses and cereals and have a significantly lower polymerisation degree than cellulose. There occur as monomers hexoses (e.g. galactose, glucose, mannose) and pentoses (e.g. arabinose, xylose). Correspondingly, hemicelluloses are also divided into hexosans and pentosans. Xylan is, in the residues of annual plants, e.g. in oat husks, the prevailing hemicellulose component with a proportion of 35 to 40% of the total mass.

A series of foodstuffs or food additives exists already on the basis of oat husks, an economical by-product of oat flake production so that the use of xylan products based on oat husks should be non-critical in foodstuffs, cosmetic goods and pharmaceuticals. In addition, in the case of products made of oats, health-promoting properties, such as e.g. lowering the cholesterol level, stabilisation of blood sugar and insulin level and also stimulation of intestinal flora, are conjectured.

It is known that the aqueous extracts of the most varied of types of hemicelluloses can form gels or hydrogels if the latter are treated with specific oxidating reagents. This process is also termed oxidative gel formation. In the literature, most of the tests for gel formation are from wheat flour and rye flour extracts. The biochemical bases of the gel formation process with biopolymers have not yet been described completely but a series of models exists (Hoseney, Faubion (1981) A mechanism for the oxidative gelation of wheat flour water-soluble pentosans, Cereal Chemistry 58, 421-424). It is assumed that a gel is formed during the intra- and/or intermolecular crosslinking of arabinoxylan and proteins, e.g. by means of ferulic acid (4-hydroxy-3-methoxycinnamic acid) or ferulic acid derivatives.

A further possibility for hydrogel formation of hemicellulose is the addition of further biopolymers, e.g. of different quantities of chitosan, described in Gabrielii Gatenholm, Glasser, Jain, Kenne (2000) Separation, characterization and hydrogel formation of hemicellulose from aspen wood, Carbohydrate Polymers 43, 367-374. The gel formation is hereby effected in a strongly acidic medium at 95° C.

Another model for gel formation or increase in viscosity of aqueous extracts of biopolymers starts with the crosslinking of macromolecular components of the hemicellulose which are caused by oxidative coupling of the ferulic acid radicals which are present. The crosslinking is initiated by corresponding oxidants and enzymes.

Only a few oxidating reagents have become known to date which cause a gel formation in biopolymers. Such reagents are for example hydrogen peroxide, usually in conjunction with an enzyme (peroxidase), ammonium peroxosulphate and formamidine disulphate.

By means of oxidative treatment, both the water-soluble and water-insoluble pentose components of the most varied of cereal flours can be processed into gels (Michniewicz et al. (1990), Cereal chemistry 67, 434-439). The oxidative gel formation of hexoses with enzymes has been known for a fairly long time (FR 2545101). A gel is thereby produced from a pectin-containing solution, obtained from sugar beets by oxidation, e.g. with hydrogen peroxide, and use of enzymes, e.g. peroxidase.

The production of hemicellulose from various brans and the oxidative gel formation by means of peroxides, e.g. with hydrogen peroxide, and enzymes, e.g. with peroxidases, are described in the patent WO 93/10158. The extraction of hemicellulose is thereby effected with hot water or under mild alkaline conditions.

A similar method but at milder temperatures for extraction of hemicelluloses whilst maintaining the gel formation tendency is described in the patent WO 00/04053. The gel formation from the cellulose is thereby effected likewise oxidatively with enzymes and oxidating species, such as hydrogen peroxide anion, hydrogen peroxide radical, hydrogen radical, superoxide radical and oxygen radical.

The most substantial disadvantages of the known technical solutions for producing gels from hemicellulose products reside in the fact that they start either from protein-containing or ferulic acid derivatives or other polysaccharides which contain crosslinking substances or the oxidative gel formation only takes place by using enzymes and/or other polysaccharides, such as e.g. chitosan. Both the use of protein-containing hemicelluloses and the additional use of enzymes or other polysaccharides greatly restrict the application possibilities of the resulting products in the field of the food industry and the pharmaceutical industry. In addition, the application of enzymes causes an increased industrial and economic complexity during production and reprocessing of the gels. Thus the inactivation of peroxidases in foodstuffs causes great difficulties since the latter are relatively heat-stable and have a capacity for regeneration. For producing protein-free gels or pastes from oat husk xylan there are no explicit details in the scientific literature.

Starting herefrom, it was the object of the present invention to provide a method for producing pastes based on hemicelluloses, which does not have the described disadvantages and in the case of which the use of enzymes can be dispensed with, as a result of which the non-critical use in foodstuffs, cosmetic and pharmaceutical products is made possible.

This object is achieved by the method having the features of claim 1 and the paste having the features of claim 15. The further dependent claims reveal advantageous developments. In claims 22 to 24, uses of the pastes according to the invention are mentioned.

According to the invention, a method for producing a stable and uncrosslinked hemicellulose paste having the following steps is provided:
a) alkaline extraction of hemicellulose from a hemicellulose-containing material such that the hemicellulose is essentially free of crosslinkable components,
b) treatment of the hemicellulose in an alkaline medium with an oxidant,
c) subsequent reduction of the pH value and
d) separation of the excess liquid until formation of a homogeneous and stable paste.

There should be understood by paste within the scope of this application both a viscous mass made of one or more components and a paste with gelatinous properties, in particular yielding point.

Surprisingly, it was able to be shown that for the production of the paste in which the use of enzymes, such as e.g. peroxidase, can be entirely dispensed with, no more oxidant is required than in the methods known from prior art. This results in a significant reduction in production costs.

It is a particular feature of the present invention that no crosslinking of the hemicellulose occurs, as is the case in the state of the art. This can be attributed to the fact that essentially no crosslinkable components are present, such as e.g. ferulic acids and derivatives thereof. This was able to be detected by means of tests on the oat husks which were used as educt. Thus the samples contained preferably at most 0.1% by weight, particularly preferred at most 0.05% by weight, of crosslinkable components, after washing and grinding only at most 0.01% by weight. This content of crosslinkable components, i.e. phenolic acids, in particular ferulic acids, is now removed by the alkaline extraction of the hemicellulose, as is implemented according to the invention, since the ester grouping of the ferulic acids in the alkaline medium are not stable. Hence the pastes according to the invention are free of crosslinkable components, such as e.g. ferulic acids.

The production according to the invention of hemicellulose paste is effected preferably from low-protein to protein-free xylan, as occurs directly during extraction, e.g. from oat husks. Complex reprocessing, such as solvent exchange, drying or the like is unnecessary here.

Preferably, the alkaline extraction is implemented in an aqueous-alkaline medium. For treatment of the hemicellulose-containing material, a 0.5 to 8% alkaline solution and a treatment temperature between 50 and 90° C. has proved to be particularly advantageous.

Production of the paste is effected under mild alkaline conditions with the addition of an oxidant, however no enzyme, such as e.g. peroxidase, being required.

Preferably, hydrogen peroxide, sodium peroxide, potassium peroxide, ozone or oxygen are used as oxidant. There are included in this group also hydrogen peroxide anions, hydrogen peroxide radicals, hydroxyl radicals, oxygen radicals, but also sodium hypochlorite, chlorine or chlorine dioxide which, under alkaline conditions, can produce the chloronium ion and protonated hypochlorous acid as oxidating species.

The addition of the oxidant can be effected according to conditions and batch size in a plurality of portions over a fairly long time period. A procedure with two portions has proved its worth in particular, once again 1 to 3 hours requiring to be ensured, before addition of the last portion, for good intermixing whilst maintaining the reaction temperature.

Precipitation of the hemicellulose from the alkaline solution is possible by adjusting the pH value to a range of 4.0 to 9.5.

Preferably, subsequently a dry content of 15 to 50% by weight of the paste can be obtained, particularly preferably by centrifugation. A subsequent adjustment of the dry content, e.g. by mixing the hemicellulose paste with distilled water, is likewise readily possible.

Because of the flexible preparation possibilities of the xylan paste, it is possible to adjust the pH value within a wide range, which could be of advantage particularly for use as a cosmetic and/or pharmaceutical product, e.g. as a skin care agent. For this purpose, the xylan paste is dispersed again in a mixture comprising hydrogen peroxide, water and methanol and the mixture is brought with a diluted alkali lye to the desired pH value (example 2). After subsequent filtration and washing, the adjustment of the dry content can be effected again by centrifugation but also by drying, e.g. in the vacuum drying cupboard, with subsequent mixing of the paste with distilled water in order to adjust the dry content.

The addition of other gel-forming biopolymers, such as e.g. chitosan, is unnecessary but in general possible, should this be required for specific applications. The product is miscible both with hydrophilic and with hydrophobic substances. Thus the absorption capacity, e.g. of water, alcohols and/or food oils or additives, such as olive oil, sunflower oil, other animal and vegetable oils and fats or even glycerine, can be estimated to be extraordinarily high whilst maintaining the pasty structure, which makes diverse use of the paste possible in foodstuffs, cosmetics or pharmaceutical products.

According to the invention, a stable paste is likewise provided which contains at least one hemicellulose obtained by alkaline extraction and at least one liquid dispersion medium, the at least one hemicellulose containing no crosslinking substances, such as e.g. ferulic acid.

In order to produce the paste, preferably xylan is used which was isolated both from vegetable fibres, e.g. from annuals, in particular oats, and from wood fibres, such as e.g. beech.

As a result of the light virtually white colour of the paste, application in combination with other pastes, gels, hydrogels, creams inter alia is entirely possible.

The hemicellulose used according to the invention has a high water retention capacity. It is consequently possible, whilst maintaining the pasty structure, to prepare a hemicellulose paste with different dry contents, which in the end also allows adjustment of different viscosities.

The paste with gelatinous properties reveals very good processing properties. The solvents which can be used during production of the paste are non-critical for the environment and do not have a health-damaging effect.

In order to clean processing machines with which the paste according to the invention is produced or processed, water can be used as cleaning agent without problem so that a simple and economical disposal of this cleaning agent is possible. Hence the paste according to the invention is environmentally and people-friendly with respect to the aspect of cleaning and disposal.

The subject according to the invention is intended to be explained in more detail with reference to the subsequent Figures and examples without wishing to restrict the latter to the embodiments mentioned in the special examples.

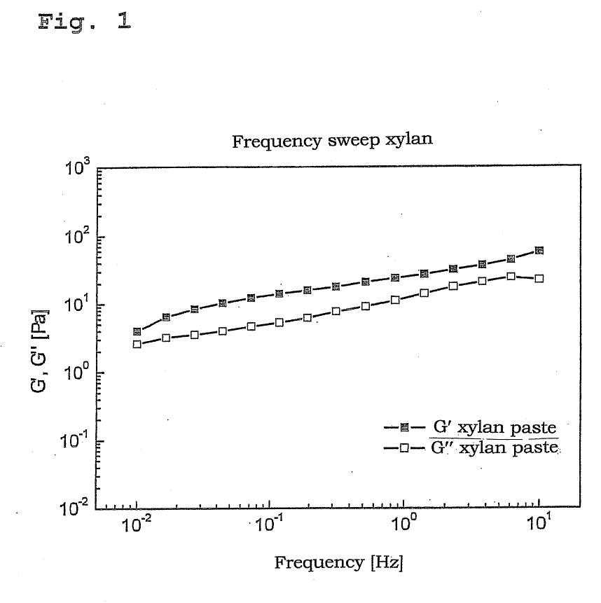

FIG. 1 shows the frequency sweep of a paste according to the invention in a diagram.

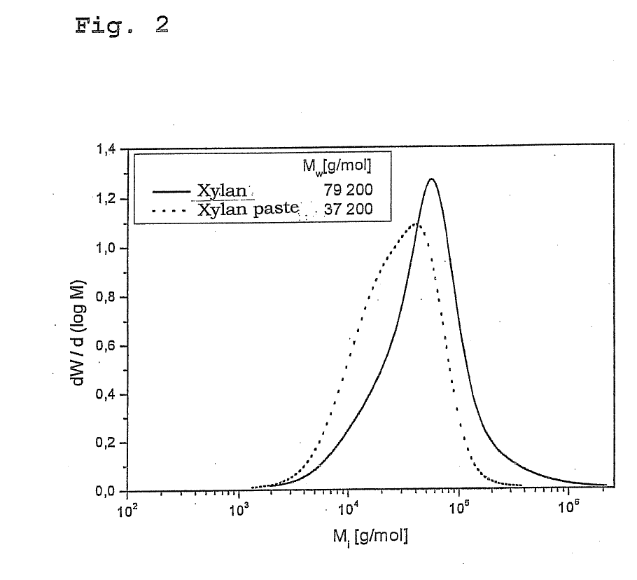

FIG. 2 shows the molar mass distribution of the paste according to the invention in comparison with the initial hemicellulose in a diagram.

The viscosity behaviour of the paste according to the invention is illustrated in FIG. 1 with reference to a diagram. G′ hereby represents the storage modulus and G″ the loss modulus. It emerges from the diagram that the storage modulus G′ is greater than the loss modulus G″, which corresponds to the behaviour of a gel. On the other hand, the paste according to the invention shows with increasing frequency an increase in the moduli, which is atypical of a gel. It is hence proved by means of these tests that in the present case a paste is involved and not a gel, as is known from the state of the art.

FIG. 2 shows the molar mass distribution of the initial xylan and of the xylan paste, produced according to the patent concept. It can be detected that, in the case of the paste, a somewhat wider molar mass distribution is present. If the paste formation is effected by crosslinking, e.g. by ferulic acid radicals, a significant increase in molar mass must be taken into account. This is unequivocally not the case here. The described paste formation can consequently not result from crosslinking reactions.

### EXAMPLE 1

Firstly 30 g oat husk xylan were dispersed in a 2 l beaker glass which was provided with a metal agitator, in 300 g 5% (w/w) NaOH solution (W_{XYL}=10%). The batch was temperature treated for 1 h at 80° C. in order to produce the solution. 5.7 g 35% (w/w) H₂O₂ were introduced into the still warm solution and this was agitated for a further 2 h. Subsequently, 4.3 g 35% (w/w) H₂O₂ were added. By adding 50% (v/v) aqueous acetic acid, a pH value of approx. 8 was set, the result being precipitation of the xylan product. Subsequently, by adding an aqueous citric acid solution, the pH value was lowered to 4.5. For separation of the product, firstly centrifugation took place for 45 min at 15,000 rpm. After decanting off the residue, centrifugation took place for 30 min at 15,000 rpm, the residue was discarded and the xylan paste obtained (TG=22.7%) was stored in a sealed vessel. Due to the described procedure, the xylan initial material was able to be transferred virtually completely into a pasty form.

### EXAMPLE 2

As described in example 1, 30 g beech xylan were dispersed in a 2 l beaker glass in 300 g 5% (w/w) NaOH solution (W_{xyl}=10%). The batch was temperature treated for 1 h at 80° C. in order to produce the solution. 5.7 g 35% (w/w) H₂O₂ were introduced into the still warm solution and this was agitated for a further 2 h. Subsequently, 4.3 g 35% (w/w) H₂O₂ were added. By adding 50% (v/v) aqueous acetic acid, a pH value of approx. 8 was set, the result being precipitation of the xylan product. Subsequently, by adding an aqueous citric acid solution, the pH value was lowered to 4.5. For separation of the product, firstly centrifugation took place for 45 min at 15,000 rpm. After decanting off the residue, centrifugation took place for 30 min at 15,000 rpm, the residue was discarded and the obtained xylan paste (TG=48%) was stored in a sealed vessel.

### EXAMPLE 3

100 g of the xylan paste from example 1 were dispersed in 200 ml of a mixture comprising 35% (w/w) hydrogen peroxide, water and methanol in the ratio 1/4/50 (v/v/v) and the mixture was adjusted with diluted NaOH to a pH=6.5. The product was separated via a frit and washed with MeOH/H₂O (90/10 v/v), MeOH and finally with acetone and dried at 40° C. in the vacuum drying cupboard (75 mbar). A xylan paste with a solid content of 25% (w/w) was mixed with distilled water.

### EXAMPLE 4

1 g of the dry product produced according to example 1 was mixed with 1 ml sunflower oil, a homogeneous dimensionally stable paste with cream-like consistency being produced.

### EXAMPLE 5

1 g of the dry product produced according to example 1 was mixed with 1 ml water and 1 ml sunflower oil, a homogeneous dimensionally stable paste with a cream-like consistency resulting.

1. A method for producing a stable and uncrosslinked hemicellulose paste comprising the following steps:
a) extracting hemicellulose from a hemicellulose-containing material in an alkaline medium such that the hemicellulose is essentially free of crosslinkable components,
b) treating the hemicellulose in the alkaline medium with an oxidant,
c) reducing the pH value and
d) separating excess liquid to form a homogeneous and stable paste of uncrosslinked hemicellulose.

2. The method according to claim 1, wherein the proportion of crosslinkable components is ≦0.1% by weight, relative to the hemicellulose-containing material.

3. The method according to claim 1, wherein the hemicellulose is free of phenolic acids as a crosslinkable component.

4. The method according to claim 3, wherein the hemicellulose is free of ferulic acids.

5. The method according to claim 1, wherein the hemicellulose-containing material is ground oat husks or beech wood flour.

6. The method according to claim 1, wherein the oxidant is hydrogen peroxide, sodium peroxide and/or peroxide.

7. The method according to claim 6, wherein the oxidant or oxidants are combined with ozone and/or oxygen.

8. The method according to claim 1, wherein 0.05 to 0.3 mol of oxidant is used per mol of anhydroglucose unit.

9. The method according to claim 1, wherein the treating of the hemicellulose is implemented in the alkaline medium at a temperature in the range of 50 to 90° C.

10. The method according to claim 1, wherein the treating of the hemicellulose is implemented over a time period of 0.5 to 4 h.

11. The method according to claim 1, wherein the reducing of value is effected by addition of an organic acid.

12. The method according to claim 1, wherein the separating of the excess liquid is effected by filtration or centrifugation up to a dry content of 10 to 60% by weight of the hemicellulose.

13. The method according to claim 1, wherein the paste is washed, dried and redispersed in water, oil or mixtures thereof subsequent to the formation of the paste.

14. The method according to claim 1, wherein the dry content of the paste is adjusted by mixing with distilled water to 15 to 50% by weight.

15. A stable paste containing at least one uncrosslinked hemicellulose obtained by alkaline extraction from hemicellulose-containing material and at least one liquid dispersion medium.

16. The paste according to claim 15, wherein the at least one uncrosslinked hemicellulose is xylan extracted from oat husks or beech wood.

17. The paste according to claim 15, wherein the proportion of uncrosslinked hemicellulose in the paste is 10 to 60% by weight.

18. The paste according to claim 15, wherein the liquid dispersion medium is water, oil or a mixture of both.

19. The paste according to claim 15, wherein the paste in the frequency sweep with increasing frequency has an increasing storage modulus G′.

20. The paste according to claim 15, wherein the storage modulus G′ is greater than the loss modulus G″ of the paste.

21. A paste produced according to the method of claim 1.

22-24. (canceled)
